(19) United States
(12) Patent Application Publication
(10) Pub. No.: US 2010/0261865 A1
(43) Pub. Date: Oct. 14, 2010

(54) METHOD FOR METALLIZING A POLYMER

(75) Inventors: Detlef Militz, Hoppegarten (DE); Dieter Kreysig, Berlin (DE)

Correspondence Address: OUIMET LAW OFFICES, 1800 9TH AVENUE, # 1630, SEATTLE, WA, 98101, US

(73) Assignee: Detlef Militz, Hoppegarten (DE)

(21) Appl. No.: 12/743,902

(22) PCT Filed: Nov. 21, 2008
(86) PCT No.: PCT/EP08/65968

§ 371 Date: Jun. 25, 2010

(30) Foreign Application Priority Data
Nov. 21, 2007 (DE) 102007056599.4-43

(51) Int. Cl. C08G 18/10

(52) U.S. Cl. 528/61

(57) ABSTRACT

The present invention relates to a method for metallizing a polymer, wherein the polymer is treated in succession
with at least one compound having at least one amine group,
with a compound having at least one functional group being suitable to perform an addition reaction with the amine group,
with a solution containing at least one metal salt selected from the group consisting of a silver salt, a copper salt, and a nickel salt, and a complexing agent, and
with at least one reducing agent.

Also, the present invention relates to polymers metallized according to this method as well as their use for the antimicrobial treatment of liquid in liquid-guiding systems or for the production of socks, insoles, clothing, covering textiles for seating furniture or mattresses.

The present invention relates to a method for metallizing a polymer. Furthermore, the present invention relates to a polymer produced according to a method for metallization as well as the use thereof. Furthermore, the present invention relates to a polymer coated with a metal.

Methods for metallizing polymers as well as metallized polymers are known in the prior art.

For instance, U.S. Pat. No. 4,681,591 describes a method for producing a metallized polyester fibre textile material having the following steps of: pre-treating the textile material comprising at least 15% by weight of polyester fibres and any type of different fibres which can be selected from cotton, polyamide 6, polyamide 66, acrylic fibres, and glass fibres, with an aqueous solution of a caustic alkali, activation-treating the pre-treated textile material with a tin (II)-containing compound and with a palladium-containing compound and non-electrolytically plating the activation-treated textile material in a mixture containing nickel, copper, cobalt, chromium, or alloys thereof to form a metal coating thereon. A textile material produced in such a way is suitable as electromagnetic radiation-shielding.

DE 34 19 755 A1 discloses a method for silver plating non-metalic materials. While doing so, a surface to be silver plated is activated with at least one compound on basis of palladium and subsequently silver plated by the use of a silver plating bath. Additionally to a silver salt, the silver plating bath contains thiocyanate ions as complexing agent and hydroxylamine as reducing agent.

A method for modifying polymer surfaces for metal deposition is disclosed in WO 2006/052548 A1, wherein a polymer is modified by an etching agent, the modified polymer is silylated to provide a polymer having amino groups, and a noble metal is deposited on the polymer containing amino groups.

DE 600 02 681 T2 describes a method for producing a substrate having biocidal properties, wherein chitosan is deposited on the substrate, the substrate is immersed in a solution of silver salt, the silver salt is reduced, the chitosan is cross-linked, and the substrate is washed.

A method for metallizing fibrous material is described in DE 689 14 485 T2, wherein the fibrous material is coated with polymers which can be functionalized. Subsequently, a metallization is carried out.

DE 38 14 506 A1 describes a method for metallization of substrate surfaces, wherein the surfaces are treated with a primer on the basis of a polymeric organic film forming agent previous to activation with complex compounds.

Especially, the metal loading and/or the metallization degree of polymers, respectively, depends on the adhesive power of the metal and/or the metal compound, respectively, to the polymer or an optional intermediate layer. An insufficient adhesive power can result in an increased and uncontrolled metal and/or metal ion release, respectively, for example, into a liquid during the use of the metallized material. Especially, in regard to environmental and waste disposal considerations and also to the profitability of such materials, an uncontrolled release of metal and/or metal ions, respectively, is disadvantageous.

Especially, the uncontrolled and often too elevated release of metal and/or metal ions, respectively, into a liquid prevents the use of a metallized polymer in liquid-guiding systems, because such polymers do not meet the system guidelines or directives and regulations which have been issued, for example, for protection of the environment or the consumer by the EU such as the EU directive 98/83 for drinking water.

Therefore, it is an object of the present invention to provide an improved method for metallizing a polymer, especially a method for metallizing a polymer, whereby a homogeneous metal coating on the polymer and a high adhesive power between metal and polymer can be achieved.

This object is solved by a method having the features of claim 1.

According to the invention, in the method for metallizing a polymer, the polymer is treated in succession at least with the following agents:
with at least one compound having at least one amine group,
with a compound having at least one functional group being suitable to perform an addition reaction with the amine group,
with a solution containing at least one metal salt selected from the group consisting of a silver salt, a copper salt, and a nickel salt, and a complexing agent, and
with at least one reducing agent.

The treatment of the polymer with a compound having at least one amine group and with a compound having at least one functional group being suitable to perform an addition reaction with the amine group provides the polymer with a functionalized layer. By treatment with a solution containing a metal salt and a complexing agent, metal is fixated by interactions, especially by coordinative and/or ionic interactions, respectively, to the functional groups of the functionalized layer. Subsequently, the ionic metal is reduced to form a metal layer. A metal plated polymer having a low metal releasability can be obtained by the method according to the invention. I. e., the metal adheres to the polymer obtained in an excellent manner.

Also, the metallized polymer obtained by the method and the use thereof are objects of the present invention. The metallized polymer is used for antimicrobially treating liquid in liquid-guiding systems or for producing socks, insoles, clothing, covering textiles for seating furniture or mattresses. Especially, the above-mentioned uses are advantageous for the silver plated polymer obtained according to the invention on one hand due to the achieved excellent adhesion of the silver to the polymer obtained according to the invention and a so-achievable reduced release of silver into the environment and on the other hand due to the biocidal effect of the silver.

Further advantageous embodiments of the present invention are described in the dependent claims.

In an advantageous embodiment, the polymer is treated with at least one compound having at least one functional group being suitable to perform an addition reaction with the amine group previous to the treatment with a compound having at least one amine group. That is, the order of these two treatment steps is interchangeable. The polymer can be treated at first with the compound having at least one amine group and then with at least one compound having at least one functional group being suitable to perform an addition reaction with the amine group or vice versa. Especially, the treatment of the polymer with the compound having at least one functional group being suitable to perform an addition reaction with the amine group at first and then with a compound having at least one amine group is carried out advantageously, if the compound having at least one amine group has strong alkaline properties and the polymer is not stable to bases. Preferably, the treatment of the polymer with a compound having at least one amine group and the treatment of the polymer with at least one compound having at least one functional group being suitable to perform an addition reaction with the amine group is carried out by spraying, wetting, placing or immersing the polymer into the respective compound which is solved in a solvent, if required. Preferably, the respective treatment is carried out at room temperature. The treatment time can be 1 minute to 10 hours.

In an advantageous embodiment, the compound having at least one amine group is a liquid polyfunctional amine. On the one side, a liquid polyfunctional amine can be applied in neat form on the polymer treated, if required, resulting in a high loading degree, eliminating possible side reactions of a solvent as well as avoiding waste products such a solvent used and working steps such as removing a solvent. On the other side, the hydrophobicity/hydrophilicity and the degree of cross-linking of the addition product with the compound having at least one functional group being suitable to perform an addition reaction with the amine group can be adjusted by means of the selection of the degree of the polyfunctionality. Especially, the adjustment of the degree of cross-linking plays a role in regard to the brittleness of the addition product produced. The higher is the degree of cross-linking of the compound having at least one amine group with the compound having at least one functional group being suitable to perform an addition reaction with the amine group, the brittler is the addition product produced. In an advantageous embodiment, the liquid polyfunctional amine is a compound having two primary amine functions and at least one secondary amine function being connected to each other by straight-chain carbon chains having 2 or 3 carbon atoms in order to obtain an addition product having a sufficient flexible property.

More advantageously, the at least one compound having at least one amine group is a compound of the Formula

R¹NHR² (I),

wherein R¹ is selected from the group consisting of H₂N(CH₂)_{w}, R³₃Si(CH₂)_{w}, and H₂NC₆H₄,

R² is selected from the group consisting of [(CH₂)ₓNH]_{y}(CH₂)_{z}NH₂, R³₃Si(CH₂)_{z}, and H₂NC₆H₄NH(CH₂)_{z},

w is an integer from 1 to 7, preferably 2 or 3,

x is an integer from 1 to 7, preferably 2 or 3,

y is zero or an integer from 1 to 7, preferably zero, 1 or 2,

z is an integer from 1 to 7, preferably 2 or 3,

R³ is a branched or straight-chain alkyl or —O-alkyl having 1 to 10 carbon atoms, preferably having 1 to 8 carbon atoms, more preferable having 1 or 2 carbon atoms.

If R¹ is H₂N(CH₂)_{w}, in an advantageous embodiment, then R² is [(CH₂)ₓNH]_{y}(CH₂)_{z}NH₂, wherein w, x, y and z are defined as above. If R¹ is R³₃Si(CH₂)_{w}, in another advantageous embodiment, then R² is R³₃Si(CH₂)_{y}, wherein R³, w and y are defined as above, i.e. the compound of the Formula (I) has silane or silanol functions, respectively.

Advantageously, the compound of the Formula (I) is selected from the group consisting of bis(3-aminopropyl)amine, N,N′-bis(2-aminoethyl)-1,3-propanediamine, triethylenetetramine, tetraethylenepentamine, bis[3-(trimethylsilyl)propyl]amine, and bis[3-(trimethoxysilyl)propyl]amine. Particularly advantageously, the compound of the Formula (I) is bis(3-aminopropyl)amine or tetraethylenepentamine.

In an advantageous embodiment of the method according to the invention, an addition reaction of the compound having at least one amine group is carried out by contacting it with a compound having at least one isocyanate group. I.e., in this embodiment, a compound having at least one functional group being suitable to perform an addition reaction with the amine group is a compound having at least one isocyanate group. A compound having at least one amine group conducts with a compound having at least one isocyanate group an addition reaction by formation of a urea. If the compound having at least one amine group has at least two amine groups and the compound having at least one isocyanate group has at least two isocyanate groups, a urea network can be formed. The formation of a network has the advantage that a layered structure being a uniform coating of the polymer is formed.

Advantageously, the compound having at least one isocyanate group is a diisocyanate. Preferably, the diisocyanate is selected from the group consisting of hexamethylene diisocyanate, tolylene diisocyanate, isophorone diisocyanate, and 4,4′-methylene-bis(cyclohexyl isocyanate). Particularly preferably, the diisocyanate is hexamethylene diisocyanate. Especially, hexamethylene diisocyanate forms with the polyfunctional amines described above on the polymer a layer which adheres firmly, but is flexible and not brittle. Brittle layers tend to drop off easily from polymeric substrate structures.

To perform an addition reaction of the compound having at least one amine group with a compound having at least one isocyanate group, the polymer is coated with the compound having at least one amine group, if necessary, used for padding, and coated with a compound having at least one isocyanate group and, if necessary, used for padding, the order of coating being interchangeable. Then, the so-treated polymer is washed, preferably with water. Then, the polymer is optionally dried. If a padding or merely a coating of the polymer is carried out with the respective compound depends on the substrate structure of the polymer. For example, if the polymer is in the form of a yarn, a padding is performed advantageously, because the padding increases the adherence of the respective compound to the polymer being already treated, if required. If the polymer is in the form of a spacer interlaced yarn, no padding is carried out, because it would result in a destruction of the substrate structure. Thus, in the method according to the invention, it is not necessary to perform padding during the treatment of the polymer with the respective compound, however it can result in better adherence properties between the respective compound and the polymer. In the basic idea of the present invention, coating the polymer with the respective compound is understood to mean spraying, wetting, placing or immersing the polymer into the respective compound. The coating of the polymer with the respective compound can take place fully or partially.

Coating the treated polymer with a compound having at least one amine group and/or a compound having at least one isocyanate group, respectively, is carried out by immersing, placing, spraying or wetting the polymer with the respective compound. Optionally, the adequate compound can be solved in a solvent. Preferably, water is employed as solvent. The concentration of the respective compound ranges from 100% to 0.1%.

Alternatively, an addition reaction of the compound having at least one amine group is carried out by contacting it with a compound having at least one epoxide group. Examples for a compound having an epoxide group are propylene oxide, styrene oxide, 4-vinyl-1-cyclohexene-1,2-epoxide, 2,3-dimethyl-2,3-epoxybutane and limonene-1,2-epoxide. Further examples for a compound having at least one epoxide group are epoxide resins, especially monomolecular or low molecular weight polymeric diglycidyl compounds having terminal epoxy groups. Preferred examples for an epoxide resin are bisphenolglycidether type epoxide resins, as they are preferably available from epichlorohydrin and bisphenol A. Such epoxide resins are commercially available. Preferably, the polymer which has been either already treated with a compound having at least one amine group or is treated subsequently with it is sprayed, wetted, immersed or placed into the compound having at least one epoxide group. While doing so, the compound having at least one epoxide group can be solved in a solvent. An aprotic solvent, more preferably an organic solvent is selected as solvent. Examples for an employable solvent include aliphatic solvents having 1 to 10 carbon atoms such as pentane, hexane, heptane, octane, nonane, decane, cyclopentane, cycloheptane, cyclooctane, dichloromethane, chloroform, 1,2-dichloroethane, diethylether, methyl-tert-butylether, tetrahydrofuran or dioxane as well as aromatic solvents such as benzene, toluene, xylene or the like which can be also used in combination, of course.

In an advantageous embodiment of the present invention, the metal salt is selected from the group consisting of silver halide, silver sulphate, silver nitrate, copper halide, copper sulphate, copper nitrate, copper acetate, nickel halide, nickel sulphate, nickel nitrate, and nickel acetate. Particularly advantageously, the metal salt used is silver nitrate, silver chloride, or silver sulphate. Even more preferably, the metal salt is silver nitrate. Especially, halide employed according to the invention comprises chloride, bromide, or iodide.

In an advantageous embodiment, the complexing agent employed into the method according to the invention is selected from the group consisting of ammonia, ethylenediamine, triethanolamine, ethanolamine, 1,3-diaminopropane, sodium thiosulphate, thioisocyanate, glycerol, sodium tartrate, potassium sodium tartrate, and sodium citrate. Particularly advantageously, the complexing agent is ammonia. Ammonia is easily volatile. Therefore, excessive ammonia can easily be removed.

Advantageously, the solution containing the metal salt and the complexing agent is an aqueous solution. Particularly advantageously, the above solution comprises water, the metal salt, and the complexing agent. Advantageously, the ratio of metal salt to complexing agent is in the range from 1:1 to 1:10, more advantageously 1:2 to 1:3 (v/v). Advantageously, the treatment of the polymer with the solution containing the metal salt and complexing agent is carried out at a temperature between 10° C. and 60° C., more advantageously between 20° C. and 50° C. The treatment time is between 5 minutes and 5 hours, advantageously between 15 minutes and 3 hours. Advantageously, the treatment is carried out by immersing and/or placing the treated polymer into the solution, respectively. Optionally, the polymer is dried subsequent to the treatment with the solution containing the metal salt and complexing agent. Advantageously, the drying is carried out at a temperature between 30° C. and 60° C., more advantageously between 40° C. and 55° C. Advantageously, the drying time is between 10 minutes and 30 minutes.

By the treatment of the polymer provided with functional groups with the solution containing the metal salt and the complexing agent, the metal is fixated by interactions, especially by coordinative and/or ionic interactions, respectively.

In a further advantageous embodiment of the present invention, the reducing agent is selected from the group consisting of glucose, ascorbic acid, sodium borohydride, sodium dithionite, sodium sulphite, sodium formate, formaldehyde, and sodium hydrophosphite. The reducing agent serves to reduce the ionic metal. Preferably, the reducing agent is glucose or ascorbic acid. Glucose and/or ascorbic acid, respectively, are a very environmentally friendly reducing agent, easy to handle, easily available and non-toxic. If the reducing agent is glucose or ascorbic acid, the reduction is preferably carried out in water, especially at temperatures between 10° C. and 60° C., preferably 20° C. and 30° C., for a period between 5 minutes and 1 day, preferably between 30 minutes and 1 hour. Especially, if glucose is used, the reducing agent is preferably employed in the form of an aqueous solution having a concentration from 1.25 to 5 g/l and a pH value in the range from 7 to 12, preferably, 8 to 10.5. For example, the pH value of the solution containing the reducing agent can be adjusted by means of addition of ammonia. If the reducing agent is sodium borohydride, the reduction is preferably carried out in ethanol, especially at temperatures between 10° C. and 50° C., preferably 20° C. and 30° C., for a period between 5 minutes and 2 hours, preferably between 15 minutes and 1 hour. Advantageously, during the treatment with the reducing agent, the polymer is immersed and/or placed and, if necessary, moved in the solution containing the reducing agent, respectively. The treatment of the polymer is carried out with a liquor ratio (ratio of the mass (kg) of the substrate to the volume (I) of the reducing agent solution) from 1:10 to 1:100, preferably 1:50 to 1:100. In an advantageous embodiment, the obtained metallized polymer is washed with water and optionally heated up to 150° C. for drying subsequent to the treatment with the solution containing the reducing agent.

Advantageously, a polymer selected from the group consisting of polyamide, polyester, polyacryl, polyurethane, polyolefin, polyether, and mixtures thereof is subjected to the method according to the invention. Further, the polymer contains one or more common auxiliary agents, processing agents or additives, if required. Particularly advantageously, the polymer is a polyamide, polyester or polyolefin. In the basic idea of the present invention, polyamide, polyester and/or polyolefin, respectively, comprise both homopolymers and copolymers. Preferably, PA 6, PA 11, PA 12, PA 66, PA 46, PA 6/6T, PA 6/6I, PA 1212, PA 612, PA 6I, PA 6I/6T, particularly preferably PA 6, PA 11, PA 12, PA 66 or PA 46, is employed as polyamide. Preferably, polyethylene terephthalate, polybutylene terephthalate, poly-1,4-cyclohexane dimethylene terephthalate, polyethylene oxybenzoate or poly-1,4-cyclohexylidene dimethylene terephthalate and mixtures thereof, particularly preferably polyethylene terephthalate or polybutylene terephthalate, is employed as polyester. Preferably, polypropylene or polyethylene, particularly preferably polypropylene, is employed as polyolefin. Especially, polyacrylnitrile is employed as polyacryl. The common auxiliary agents, processing agents or additives include but are not limited to stabilizing agents, flame retardants, processing aid agents, static inhibitors, antioxidant agents, plasticizers, coloring agents, impact strength modifying agents, adhesion modifying agents, pigments, reinforcing agents and/or fillers. Preferred examples for the common auxiliary agents, processing agents or additives include but are not limited to short glass fibers, glass beads, C fibers, carbon black, chalc, mica, talc, baryte, mica, wollastonite, calcium carbonate, titanium dioxide, nanocomposites, graphite, MoS₂ , silicates, aluminum, copper, bronze, steel, lead, zinc, nickel. Further, the term “additives” comprises also fiber materials of every kind which allow to be integrated by textile manufacturing in the polymer.

In an advantageous embodiment of the method according to the invention, the polymer is treated with an agent selected from the group consisting of reducing agent, complexing agent, and polymer subsequent to the step of the treatment with a reducing agent. The operating principles of the agent are the reduction of possibly remaining ionic metal amounts in the area of the surface of the metallized polyester, the removal of possibly remaining ionic metal amounts from the metallized polymer by means of complexation and/or a sealing of the metallized polymer, respectively. These strategies of action serve to prevent an uncontrolled high metal and/or metal ion release from the metallized polymer to the environment, respectively. Thus, in the basic idea of the present invention, such a treatment of the metallized polymer serves as a method for reduction of metal ions, for complexation of metal ions and/or sealing of a metal coating, respectively, in order to effect an appropriate metal release controlled according to the respective application field. As a result, there are achieved not only a higher profitability, lower waste disposal costs and lower damage to the environment, but also a controlled sustained release during the application. A controlled sustained release during the application means that a metal release authorized according to the respective directives, system guidelines and regulations occurs in a constant manner for a long period. Thereby, a long active time and, as a result, a long utilizability of the metallized polymer is obtained.

The treatment of the metallized polymer with a reducing agent is especially advantageous. The above-mentioned reducing agents are employed as reducing agent. The treatment conditions are the same as already mentioned above. In the case of polymer silver plated according to the invention, a preferred reducing agent is glucose. The reducing effect of aqueous glucose solutions is dependent on a.o. the glucose concentration and the pH-dependent red ox potential being dependent on the pH value in a linear manner. The silver release of the silver plated polymer subsequent to the treatment with the reducing agent decreases in a linear manner at elevating pH value of the reducing solution and at elevating oxidation potential. I.e., by treating the metallized polymer with the reducing agent, the metal and/or metal ion release, in this case the silver and/or silver ion release, respectively, of the metallized polymer in a surrounding liquid can be adjusted to a determined value.

In another preferred embodiment, the agent is a complexing agent. An above-mentioned complexing agent is employed as complexing agent. The metallized polymer is rinsed with the complexing agent which can be in aqueous solution. Subsequently, the treated polymer is washed with water, if necessary, and dried at a temperature up to 140° C., if necessary.

In another preferred embodiment, the agent is a polymer. Preferably, the polymer is selected from the group consisting of polyurethane, polyacrylate, and finishing agent for high quality.

A metallized polymer is obtained by means of the method according to the invention. Especially, a silver plated, copper plated or nickel plated polymer is obtained by means of the method according to the invention. Particularly preferably, silver plated polymer is obtained by means of the method according to according to the invention. According to the basic idea of the present invention, the metallized polymer can be a fully or partially metallized polymer.

Advantageously, the metallized polymer obtained by the method according to the invention is formed as a yarn, a fibre, a filament, a woven fabric, a knitted fabric, a meshing, an interlaced yarn or a non-woven fabric. Advantageously, the metallized polymer obtained by the method according to the invention is a fibre. Especially, it is suitable for producing socks and clothing in that case. In another advantageous embodiment of the present invention, the obtained metallized polymer is an interlaced yarn, particularly a spacer interlaced yarn. Especially, the spacer interlaced yarn is suitable for antimicrobially treating liquid in liquid-guiding systems and insoles.

Also, the present invention relates to a coated polymer comprising a polymer having a layer of an addition product from a compound having at least one amine group and compound having at least one functional group being suitable to perform an addition reaction with the amine group, and a layer of at least one metal selected from the group consisting of silver, copper, and nickel. The metal layer adheres to the metallized polymer in an excellent manner by means of the layer of the addition product.

Preferably, the coated polymer comprises a polymer having a layer of urea and a layer of silver. Preferably, the urea is obtained by an addition reaction from at least one compound having at least one amine group with at least one compound having at least one isocyanate group.

Preferably, the urea is an addition product from at least one compound of the Formula

R¹NHR² (I),

wherein R¹ is selected from the group consisting of H₂N(CH₂)_{w}, R³₃Si(CH₂)_{w}, and H₂NC₆H₄,

R² is selected from the group consisting of [(CH₂)ₓNH]_{y}(CH₂)_{z}NH₂, R³₃Si(CH₂)_{y}, and H₂NC₆H₄NH(CH₂)_{y},

w is an integer from 1 to 7, preferably 2 or 3,

x is an integer from 1 to 7, preferably 2 or 3,

y is zero or an integer from 1 to 7, preferably zero, 1 or 2,

z is an integer from 1 to 7, preferably 2 or 3, and

R³ is a branched or straight-chain alkyl or —O-alkyl having 1 to 10 carbon atoms, preferably having 1 to 8 carbon atoms, more preferably having 1 or 2 carbon atoms, and

a compound selected from the group consisting of hexamethylene diisocyanate, tolylene diisocyanate, isophorone diisocyanate, and 4,4′-methylene bis(cyclohexylisocyanate).

A polymer obtained by using the method according to the invention is suitable for an antimicrobial treatment of liquids in a liquid-guiding system. Especially, a silver plated polymer is suitable for it, since due to its excellent antimicrobial effect, silver is capable to effectively inhibit especially bacteria, fungi and micro algae. Alternatively, the metallized polymer is used for producing socks, insoles, clothing, covering textiles for seating furniture or mattresses. Also, in this case, a silver plated polymer is especially suitable due to the particular powerful oligodynamic properties.

Especially, the metallized polymer is employed in the treatment of a liquid in the form of a process liquid or in the form of drinking water. These liquids can be in systems being closed or open to the surrounding atmosphere, stagnating or circulating, in power stations, industrial or commercial plants or air conditioners. In each case, the metal elution of the polymer according to the invention can be individually adjusted in such a manner that, for example, distinct national directives in regard to the maximum authorized metal concentration in drinking water are met during the use for treating liquid in the form of drinking water.

The term of the “process liquid” serves as a generic term for a liquid which fulfils one or more functionalities such as cooling, lubricating, hydraulically switching, and controlling or is consumed as service or industrial liquid.

A preferred use is the antimicrobial treatment of a liquid in a liquid-guiding system comprising the treatment of a liquid cooling lubricant in the cooling lubricant circulation of a metal-working plant. Such cooling lubricating liquids are generally employed in industrial and commercial plants working metals by intervention on the substance such as turning, milling or drilling. The use is especially advantageous, if the cooling lubricating liquid is employed as water-oil-emulsion in a cooling lubricating liquid system. Thereby, the cooling lubricating liquid remains microbiologically stable without the need of the biocides usual so far, particularly on basis of formaldehyde. This leads to lower health stress of the operating staff and lower costs by higher service life. By means of the method according to the invention, the release of antimicrobial acting metal components can be optimally adjusted to the requirements.

A further preferred use is the antimicrobial treatment of a liquid in a liquid-guiding system comprising the treatment of a liquid switching medium in a hydraulic switching circuit of an industrial plant. Also, in hydraulic switching circuits, biological mass growth can be a problem. Especially, this applies for circuits having regions through which material which is suitable as food for a lot of micro organisms comes regularly into the hydraulic medium. For example, this applies for plants contacting cellulose containing materials. Also, this applies for materials having natural fibers like cotton, linen, wool, etc. Thus, the method is particularly advantageously employable, where the industrial or commercial plant is formed as paper producing and/or processing plant or as plant for producing and/or processing textiles. Also, as mentioned above, the adjustment of the elution of oligodynamically active metal ions tailored to requirements is given in this case.

A further preferred use is the antimicrobial treatment of a liquid in a liquid-guiding system in a washing apparatus for laundry comprising the treatment of retained laundry rinsing water. In this way, it is possible to store the retained laundry rinsing water in a tank without risking that this water becomes unsuitable due to microbial activity in the long run. Especially, this is always true in that case, if, for example, substances being a good nutrimental basis for microorganisms are washed out, while rinsing the laundry. Especially, that is the case, when washing natural fiber textiles. Thus, it is particularly advantageous that the treated laundry rinsing water will be employed as washing water for a newly starting washing step of the washing apparatus. By the fact that, f. e., the rinsing water of the last rinsing procedure in washing machines is stored for the use as first washing water in a new washing step, a further reduction of the water consumption of washing machines can be realized in an easy manner. This effect can be adopted to further washing apparatuses and washing processes for different laundries.

A further preferred use is the antimicrobial treatment of a liquid in a liquid-guiding system in a medical technical device comprising the treatment of sterile process water. Then, there is a regular need to ensure high requirements in regard to an enduring sterility of the water and a piping system coming in contact therewith. This can be ensured in an easy and reliable manner by using a three-dimensional fiber system having oligodynamic activity.

Now, the present invention is explained in more detail by referring to an application example. However, the present invention is not limited to the application example.

### EXAMPLE

A polyester spacer interlaced yarn was immersed for 1 minute into hexamethylene diisocyanate (20% in water) and then for 3 hours into bis(3-aminopropyl)amine. The so-treated polyester was allowed to dry for 1 day at 20° C. The so-treated polyester was heated in a mixture of aqueous silver nitrate solution (5%) and ammonia solution (25%) with a liquor ratio of 1:1 for 3 hours at 50° C. with stirring. The so-treated polyester was placed in an aqueous ascorbic acid solution (10%) at pH =11. By a post-treatment of the so-silver plated polyester with a mixture of aqueous silver nitrate solution (5%) and ammonia solution (25%) for 10 minutes with stirring, the silver plating degree could be further increased.

1. A method for metallizing a polymer, wherein the polymer is treated in succession
with at least one compound having at least one amine group,
with a compound having at least one functional group being suitable to perform an addition reaction with the amine group,
with a solution containing at least one metal salt selected from the group consisting of a silver salt, a copper salt, and a nickel salt, and a complexing agent, and
with at least one reducing agent.

2. The method according to claim 1, characterized in that the step of treating with a compound having at least one functional group being suitable to perform an addition reaction with the amine group is performed previous to the step of treating with a compound having at least one amine group.

3. The method according to claim 1, characterized in that the at least one compound having at least one amine group is a compound of the Formula
R¹NHR² (I),
wherein R¹ is selected from the group consisting of H₂N(CH₂)_{w}, R³₃Si(CH₂)_{w}, and H₂NC₆H₄,
R² is selected from the group consisting of [(CH₂)ₓNH]_{y}(CH₂)_{z}NH₂, R³₃Si(CH₂)_{z}, and H₂NC₆H₄NH(CH₂)_{z},
w is an integer from 1 to 7, preferably 2 or 3,
x is an integer from 1 to 7, preferably 2 or 3,
y is zero or an integer from 1 to 7, preferably zero, 1 or 2,
z is an integer from 1 to 7, preferably 2 or 3,
R³ is a branched or straight-chain alkyl or —O-alkyl having 1 to 10 carbon atoms, preferably having 1 to 8 carbon atoms, more preferably having 1 or 2 carbon atoms.

4. The method according to claim 1, characterized in that the compound having at least one amine group is selected from the group consisting of bis(3-aminopropyl)amine, N,N′-bis(2-aminoethyl)-1,3-propanediamine, triethylenetetramine, tetraethylenepentamine, bis[3-(trimethoxysilyl)propyl]amine, and bis[3-(trimethylsilyl)propyl]amine.

5. The method according to claim 1, characterized in that the at least one compound having at least one functional group being suitable to perform an addition reaction with the amine group has at least one isocyanate group, preferably is a compound having two isocyanate groups.

6. The method according to claim 5, characterized in that the compound having at least one isocyanate group is selected from the group consisting of hexamethylene diisocyanate, tolylene diisocyanate, isophorone diisocyanate, and 4,4′-methylene-bis(cyclohexyl)isocyanate, wherein hexamethylene diisocyanate is especially preferred.

7. The method according to claim 1, characterized in that the at least one compound having at least one functional group being suitable to perform an addition reaction with the amine group has at least one epoxide group, wherein the compound having at least one epoxide group is preferably selected from the group consisting of propylene oxide, styrene oxide, 2,3-dimethyl-2,3-epoxybutane, 4-vinyl-1-cyclohexene-1,2-epoxide, limonene-1,2-epoxide, and epoxide resin, especially bisphenolglycidether type epoxide resin.

8. The method according to claim 1, characterized in that the metal salt is selected from the group consisting of silver halide, silver sulphate, silver nitrate, copper halide, copper sulphate, copper nitrate, copper acetate, nickel halide, nickel sulphate, nickel nitrate, and nickel acetate, that the metal salt is preferably silver nitrate, silver chloride or silver sulphate.

9. The method according to claim 1, characterized in that the complexing agent is selected from the group consisting of ammonia, ethylenediamine, triethanolamine, ethanolamine, 1,3-diaminopropane, sodium thiosulphate, thioisocyanate, glycerol, sodium tartrate, potassium sodium tartrate, and sodium citrate.

10. The method according to claim 1, characterized in that the reducing agent is selected from the group consisting of glucose, ascorbic acid, sodium borohydride, sodium dithionite, sodium sulphite, sodium formate, formaldehyde, and sodium hydrophosphite.

11. The method according to claim 1, characterized in that the polymer is selected from the group consisting of polyamide, polyester, polyacryl, polyurethane, polyolefin, polyether, and mixtures thereof.

12. The method according to claim 1, characterized in that subsequent to the step of the treatment with a reducing agent, the polymer is treated with an agent selected from the group consisting of reducing agent, complexing agent, and polymer.

13. A metallized polymer, obtained by the method according to claim 1.

14. The metallized polymer according to claim 13, characterized in that it is formed as a yarn, a fibre, a filament, a woven fabric, a knitted fabric, a meshing, an interlaced yarn or a non-woven fabric.

15. A use of a polymer according to claim 13 for an antimicrobial treatment of a liquid in a liquid-guiding system or for a production of socks, insoles, clothing, covering textiles for seating furniture or mattresses.
